(19) United States
(12) Patent Application Publication
(10) Pub. No.: US 2026/0084169 A1
(43) Pub. Date: Mar. 26, 2026

(54) SOURCE BOTTLE AND REFILLABLE DISPENSER ASSEMBLY

(71) Applicant: APTAR FRANCE SAS, LE NEUBOURG (FR)

(72) Inventors: Stéphane BERANGER, SURTAUVILLE (FR); Sébastien BILQUEZ, MARCILLY SUR EURE (FR)

(73) Assignee: APTAR FRANCE SAS, LE NEUBOURG (FR)

(21) Appl. No.: 19/111,082

(22) PCT Filed: Jun. 30, 2023
(86) PCT No.: PCT/FR2023/051008

§ 371 Date: Mar. 28, 2025

(30) Foreign Application Priority Data
Sep. 14, 2022 (FR) FR2209262
Feb. 7, 2023 (FR) FR2301142

(51) Int. Cl. B05B 11/00; B05B 11/10

(52) U.S. Cl. CPC B05B 11/0056; B05B 11/0097; B05B 11/1043

(57) ABSTRACT

An assembly having a source bottle and a refillable dispenser, the source bottle having a body and a threaded neck formed of one-piece, the refillable dispenser having a dispensing head and a filling and venting system, the refillable dispenser having a reservoir, The refillable dispenser has a threaded sleeve that can be screwed onto the threaded neck, thereby enabling the filling and venting system to be connected to the body, so that the fluid product in the source bottle can gravitationally flow from the source bottle into the reservoir through the filling and venting system, while the air from the reservoir can simultaneously flow from the reservoir into the source bottle through the filling and venting system.

The present invention relates to a dispensing assembly comprising a source bottle and a refillable dispenser, for the purpose of refilling the refillable fluid product dispenser using the source bottle. The invention also relates to a filling method implementing the dispensing assembly of the invention. The preferred field of application of the present invention is that of perfumery, cosmetics or even pharmacy. This type of refillable dispenser is often designated under the term “travel” dispenser. In general, it presents a reservoir of small capacity of about 10 ml at most and is fitted with a pump that can be actuated by pressing on a push-button. It also comprises a filling valve at its bottom end, opposite the push-button.

In the prior art, document EP 2791031A1, is known, for example, which describes a refillable dispenser fitted with a filling valve that can be actuated by means of the actuating rod of a pump mounted on a source bottle. The refillable dispenser also integrates a venting valve that evacuates air from the refillable dispenser reservoir to the outside. The disadvantage is that the fluid product at the end of filling is also discharged through the venting valve, which soils the refillable dispenser and the source bottle. This is not acceptable.

Document EP2500277A1 is also known, which describes a dispensing assembly, the source bottle of which is fitted with a filling and venting system by flow crossing. The refillable dispenser does not comprise a filling valve: its dispenser head must first be removed so as to be able to screw the filling and venting system onto its threaded neck. At the end of the filling operation, the dispensing head must again be screwed back onto the reservoir of the refillable dispenser. In all, therefore, it is necessary to carry out two unscrewing and two screwing operations. This is tedious and a source of loss of fluid product.

Document EP2719466 is also known, which describes a dispensing assembly, the refillable dispenser of which is fitted with a filling and venting system that is mounted on a source bottle by means of a specific bayonet connection. More precisely, a bushing is mounted permanently on the non-threaded neck of the source bottle. Furthermore, the filling and venting system comprises a valve which opens by gravity and which is retained in the closed position by a magnetic attraction generated by a magnet mounted in a stopper covering the filling and venting system. Thus, as soon as the stopper is removed, the refillable dispenser may leak, if it is tilted or knocked over. This is not acceptable.

The present invention aims to remedy the above-mentioned disadvantages of the prior art by defining a dispensing assembly, the refillable dispenser of which can easily be mounted on a standard source bottle. Another aim is that the filling is conditioned by the controlled actuation of a valve.

To do this, the present invention proposes an assembly comprising a source bottle and a refillable dispenser, the source bottle, advantageously made of glass, comprising a body containing a fluid product and a threaded neck being made in one-piece with the body, the refillable dispenser defining a longitudinal axis X and comprising at an upper end a dispensing head provided with a push-button and at a lower end a filling and venting system, the refillable dispenser comprising a reservoir in communication with both the dispensing head and the filling and venting system,
characterised in that the refillable dispenser integrates a threaded sleeve capable of screwing onto the threaded neck of the source bottle, the filling and venting system then being connected to the body, so that the fluid product in the source bottle can flow by gravity from the source bottle into the reservoir through the filling and venting system, and so that the air in the reservoir can flow simultaneously from the reservoir into the source bottle through the filling and venting system.

The threaded sleeve is permanently connected to the refillable dispenser, so that it is inseparable from it. Advantageously, the threaded sleeve is an integral and inseparable part of the filling and venting system, which is mounted in a permanent manner on the reservoir.

The spirit of the invention is to integrate all the functionalities necessary for the flow crossing and connection in the refillable dispenser, so that it can be screwed onto a standard bottle, particularly made of glass, which can be made in one-piece with a threaded neck. The source bottle does not integrate any particular feature intended to cooperate with the filling and venting system of the refillable dispenser, which only cooperates with the standard threaded neck of the source bottle.

According to another feature of the invention, the reservoir can comprise a glass tube defining two openings, the filling and venting system being mounted in a permanent manner on one opening of the glass tube, while the dispensing head is mounted in a permanent manner on the other opening of the glass tube.

Initially, the source bottle may be provided with a dispensing head removably screwed onto the threaded nec, to be replaced by the refillable dispenser.

According to another particularly interesting aspect of the invention, the filling and venting system can comprise a controllable valve, which is manually actuated, by an axial movement along the longitudinal axis X induced by a traction or a rotation, between a closed state and an open state. This means that it is a dedicated or induced manipulation by the user who will switch the valve between its closed and open states. In document EP2719466, it is gravity that carries out this permutation.

Advantageously, the controllable valve comprises a valve seat and a valve member, the valve seat being integral in movement with the threaded sleeve.

According to another aspect, the filling and venting system can comprise a fixed part mounted on the reservoir and a movable part capable to move axially relative to the fixed part over a determined axial travel, generating the opening, respectively the closing, of the controllable valve.

According to a first embodiment, the threaded sleeve may be formed by the movable part, the valve member being a free member (a ball for example) which is pressed against the valve seat by the fixed part in the closed state and which is free to detach itself from the valve seat in the open position. Advantageously, the movable part forms a flow crossing duct, one end edge of which forms the valve seat. The threaded sleeve and the flow crossing duct can be made as two separate parts or in one-piece.

Alternatively, the free member can be replaced by a blocking member integral to the fixed part and which cooperates with the valve seat formed by the movable part.

According to a second embodiment, the threaded sleeve may be formed by the fixed part, the movable valve member being formed by the movable part and is pressed on the valve seat by a return spring in the closed state and is detached from the valve seat against the force exerted by the return spring in the open position, by axial pressing of the movable part on the threaded neck, when the threaded sleeve is screwed onto the threaded neck. Advantageously, the movable part forms a flow crossing duct, on which the valve member is securely mounted.

According to a third embodiment, the fixed part and the movable part are rotatable relative to one another, the fixed part and the movable part together defining a cam system capable of generating a relative axial movement along the longitudinal axis of the fixed part relative to the movable part by the relative rotation of the fixed part relative to the movable part. This type of cam system makes it possible to transform a rotation, generally exerted by a user on a rotary actuating member, into a movement or axial movement of another member, in order to switch between a passive state and an active state.

Advantageously, the cam system comprises an inclined helical ramp formed by one of the fixed part and the movable part and a cam formed by the other of the fixed part and the movable part, the cam sliding along the inclined helical ramp upon relative rotation of the fixed part relative to the movable part. The term “ramp” can be replaced by thread, threading, slope, edge, ridge, rib, groove, etc. The term “cam” can be replaced by profile, lug, tab, slider, etc.

According to another aspect of this third embodiment, a spring can act between the fixed part and the movable part so as to urge the fixed part towards the movable valve member to press it on its valve seat, the cam system, in one direction of rotation, moving the fixed part away from the movable valve member so that it can detach from its valve seat, corresponding to the open state of the controllable valve, and in the other direction of rotation, pushing the movable valve member onto its valve seat, corresponding to the closed state of the controllable valve. Thus, the cam system of the invention makes it possible to open the controllable valve against the force exerted by the spring and the closure of the controllable valve assisted by spring, which urges the fixed part against the movable valve member to press it against its valve seat.

According to another feature of this third embodiment, the movable part, already forming the threaded sleeve and the valve seat, also forms a sliding barrel, the fixed part forming a lip duct engaged in sealed sliding in the sliding barrel, the lip duct advantageously forming a thrust pin intended to come into contact with the movable valve member to push it onto its valve seat. The lip duct is located downstream of the controllable valve and connects the reservoir of the refillable dispenser to the controllable valve. By rotating the fixed part relative to the movable part, or vice versa, the cam system axially moves the fixed part relative to the movable part, which results in a sliding of the lip duct to the fixed part inside the sliding barrel of the movable part.

Advantageously, the movable part can also form an inlet pipe upstream of the valve seat inside the threaded sleeve, the inlet pipe forming an axial opening and a lateral opening, the lateral opening being advantageously located close to the valve seat. The fluid product from the source bottle will travel from top to bottom through the lateral opening, while the air from the refillable dispenser will travel from bottom towards the top through the axial opening.

According to another embodiment, the threaded sleeve and the valve seat are formed by the movable part, the valve member is formed by the fixed part, a spring acting between the fixed part and the movable part so as to urge the valve member towards the valve seat, the fixed part and the movable part being movable against the spring by a traction along the longitudinal axis to detach the movable member from the valve seat and thus, bring the controllable valve into the open position, the spring automatically returning the controllable valve to the closed position, as soon as the traction is released. This embodiment may be implemented without a threaded sleeve. Once the refillable dispenser is connected to the source bottle, the user pulls on the refillable dispenser to move it away from the source bottle. It then holds the traction up to the desired filling level. By releasing the traction, the controllable valve automatically closes under the return action of the spring.

According to another embodiment, the threaded sleeve and the valve seat are formed by the movable part, the valve member is formed by the fixed part, a spring acting between the fixed part and the movable part so as to urge the valve member towards the valve seat, the fixed part and the movable part together defining a cam system capable of generating a relative axial movement along the longitudinal axis of the fixed part relative to the movable part by the relative rotation of the fixed part relative to the movable part, the fixed part and the movable part being movable against the spring by an opening torque to detach the movable member from the valve seat and thus, bring the controllable valve into the open position, the spring automatically returning the controllable valve to the closed position, as soon as the opening torque is released. This embodiment may be implemented without a threaded sleeve. Once the refillable dispenser is connected to the source bottle, the user turns the refillable dispenser while holding the source bottle. It then holds the torque up to the desired filling level. By releasing the torque, the controllable valve automatically closes under the return action of the spring.

According to another embodiment, the threaded sleeve and the valve seat are formed by the fixed part, the valve member is formed by the movable part, a spring acting between the fixed part and the movable part so as to urge the valve member towards the valve seat, the fixed part and the movable part being movable against the spring by screwing the threaded sleeve onto the threaded neck of the source bottle to detach the movable member from the valve seat and thus, bring the controllable valve into the open position, the movable part advantageously incorporating a ball valve comprising a ball seat and a ball that moves freely by gravity, the ball resting on its ball seat, when the refillable dispenser is in the upright position. This embodiment may be implemented without a threaded sleeve. In this embodiment, the main valve is separated from the temporary valve (free ball).

The invention also defines a method of filling a refillable dispenser by means of a source bottle, the source bottle, advantageously made of glass, comprising a body containing a fluid product and a threaded neck made in one-piece with the body, the source bottle being provided with a dispensing head removably screwed onto the threaded neck, the refillable dispenser defining a longitudinal axis X and comprising at an upper end a dispensing head provided with a push-button and at a lower end, a filling and venting system, the refillable dispenser comprising a reservoir in communication both with the dispensing head and the filling and venting system, the refillable dispenser incorporating a threaded sleeve capable of screwing onto the threaded neck of the source bottle,
the filling method comprising the following successive steps:
a—unscrew the dispenser head from the threaded neck,
b—screw the refillable dispenser onto the threaded neck,
c—turning over the assembly thus formed, to arrange the source bottle above the refillable dispenser,
d—let the fluid product from the source bottle to flow by gravity into the reservoir through the filling and venting system, and let the air from the reservoir to flow simultaneously from the reservoir into the source bottle through the filling and venting system,
e—turning over the assembly thus formed, to once again place the refillable dispenser above the source bottle,
f—unscrew the refillable dispenser on the threaded neck, and
g—optionally, screw the dispensing head back onto the threaded neck.

According to one embodiment, the filling and venting system comprises a controllable valve, which is manually actuated by an axial movement along the longitudinal axis X between a closed state and an open state, the method comprising an additional step between the steps c—and d—consisting in pulling on the refillable dispenser while holding the source bottle. The user must therefore, carry out a dedicated traction operation to open the valve. The return to the closed state can be carried out automatically under the action of a return spring or by another dedicated pushing operation carried out by the user.

According to another embodiment, the filling and venting system comprises a controllable valve, which is manually actuated by an axial movement along the longitudinal axis X between a closed state and an open state, this axial movement being induced by the step b—of screwing the refillable dispenser onto the threaded neck. The user is not even aware that simply screwing the travel dispenser in, causes the valve to open and the unscrewing causes the valve to close.

In yet another embodiment, the method comprises an additional step between steps c—and d—consisting in rotating the refillable dispenser while holding the source bottle. The return to the closed state can be carried out automatically under the action of a return spring or by another dedicated reverse rotation operation carried out by the user.

The invention will now be described in more detail, with reference to the accompanying drawings, which show, by way of non-limiting examples, two embodiments of the invention.

### ON THE FIGURES

FIG. 1a is a schematic side view of a source bottle with its dispensing head removed,

FIG. 1b is a partially transparent schematic side view of a refillable dispenser according to the invention,

FIG. 2a is an exploded cross-sectional view of a filling and venting system according to a first embodiment of the invention;

FIG. 2b is a view similar to that of FIG. 2a in the assembled state and closed position;

FIG. 2c is a view similar to that of FIG. 2b upside down in the open position,

FIGS. 3a and 3b are perspective views of the filling and venting system of FIGS. 2a to 2c, respectively in the closed position and in the open position,

FIGS. 4a, 4b and 4c are views respectively similar to FIGS. 2a, 2b and 2c for a variant of the first embodiment of the invention,

FIGS. 5a, 5b and 5c are schematic views aiming to illustrate the different steps of the filling operation of the refillable dispenser of the invention using the source bottle,

FIGS. 6a, 6b and 6c are views respectively similar to FIGS. 2a, 2b and 2c for a second embodiment of the invention of the filling and venting system,

FIGS. 7a and 7b are views respectively similar to FIGS. 3a and 3b for this second embodiment of the invention,

FIGS. 8a, 8b and 8c are views respectively similar to views 5a, 5b and 5c, for the purpose of illustrating the different filling steps of filling the “travel” dispenser incorporating a filling and venting system according to the second embodiment of the invention,

FIG. 9 is a vertical cross-sectional view through a refillable dispenser incorporating a filling and venting system according to a third embodiment of the invention;

FIG. 10a is an exploded, cropped perspective view of the filling and venting system according to the third embodiment of the invention,

FIG. 10b is a perspective view of a portion of the filling and venting system according to the third embodiment,

FIGS. 11a and 11b are enlarged, vertical cross-sectional views through the filling and venting system according to the third embodiment, respectively in the closed position and in the open position,

FIGS. 12a to 12f are vertical cross section views showing the refillable dispenser according to the third embodiment mounted on a source bottle, during various filling phases,

FIGS. 13a and 13c are enlarged, vertical cross-sectional views through a filling and venting system according to a fourth embodiment, respectively in the closed position and in the open position,

FIG. 13b is a perspective view of a portion of the filling and venting system according to the fourth embodiment, in the closed position,

FIG. 14 is an enlarged vertical cross-sectional view through a filling and venting system according to a fifth embodiment, in the closed position, and

FIG. 15 is an enlarged vertical cross-sectional view through a filling and venting system according to a sixth embodiment, in the closed position.

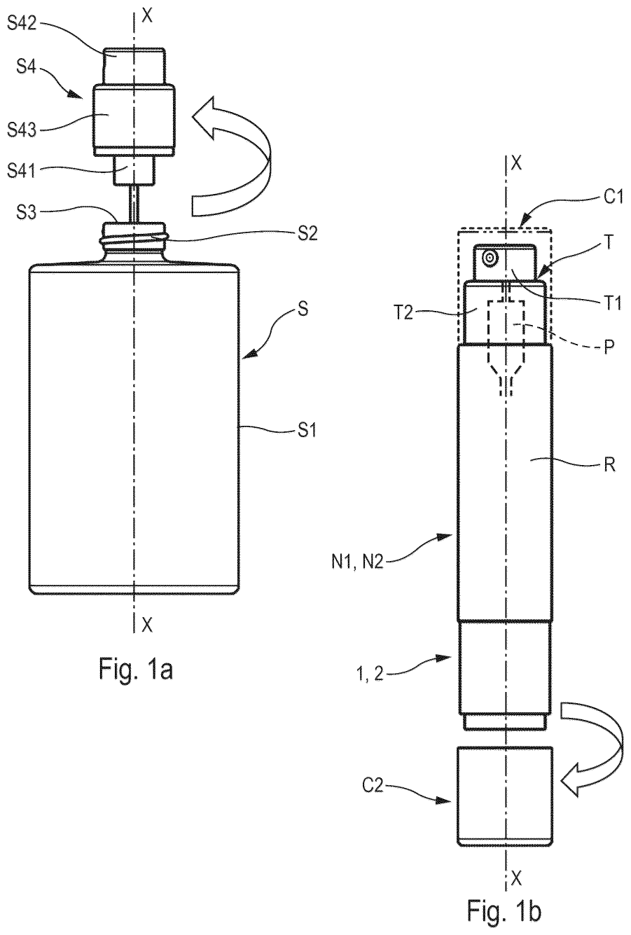

Reference will first be made to Figures 1a and 1b to describe in a brief manner the structure of a refillable or “travel” dispenser and a source bottle S. The combination of these two entities forms the dispensing assembly of the invention, the purpose of which is to fill the travel dispenser with the source bottle S, without overpressure and without overflow leakage.

The source bottle S can present a conventional overall design in the fields of perfumery, cosmetics, or even pharmacy. The source bottle S can be limited to a simple one-piece glass bottle formed of a body intended to contain fluid product and a threaded neck that projects above the body. Clearly, the source bottle S can also be provided with accessories, which do not alter the one-piece design of the body and the threaded neck.

The source bottle S can, for example, be provided with a dispenser head S4, which can comprise a pump S41 covered by a push-button S42 and mounted removably on the threaded neck S2 by means of a threaded ring S43. In Figure 1a, the rounded arrow indicates that the dispenser head S4 can be removed by rotation in an unscrewing movement. Thus, the source bottle S can be summed up as the body S1 with its integrated threaded neck S2. The source bottle S can be made of any suitable material, and advantageously of glass. The threaded neck S2 can meet the standard of dimensions in the fields of perfumery and of cosmetics.

The “travel” refillable dispenser is available in two embodiments according to the invention. In FIG. 1b, the “travel” refillable dispenser corresponds indifferently to the first or second embodiment, which is why it is designated by N1 for the first embodiment and by N2 for the second embodiment. The refillable dispenser comprises first of all a reservoir R intended to contain a fluid product. At its upper end, the reservoir R is provided with a dispenser head T that can comprise a pump P covered with a push-button T1 and mounted in a definitive or permanent manner on the reservoir R by means of a fastening ring T2. At its lower end, the reservoir R is provided with a filling and venting system, which is available in two versions 1 and 2, corresponding to the two embodiments of the invention. These filling and venting systems 1, 2 will be described in detail below.

Optionally, the refillable dispenser N1, N2 can be provided with an upper cap C1 covering the dispenser head T and a lower cap C2 covering the filling and venting system 1, 2.

Very generally, this refillable dispenser N1, N2 is characterised by a fluid product reservoir R, which communicates both with a dispenser head T at its upper end and with a filling and venting system 1, 2 at its lower end.

According to a particular embodiment, the reservoir R can be made of glass, and particularly, in the form of a stretched glass tube, which defines two opposite openings, one receiving the dispensing head T and the other receiving the filling and venting system 1, 2.

According to the invention, the filling and venting system 1, 2 is integrated into the refillable dispenser N 1, N2, so that it is inseparable therefrom. The user cannot remove the filling and venting system from the reservoir without harming the integrity of the refillable dispenser. It is therefore, not possible to remove this filling and venting system from the “travel” dispenser to mount it on the threaded neck S2 of the source bottle S.

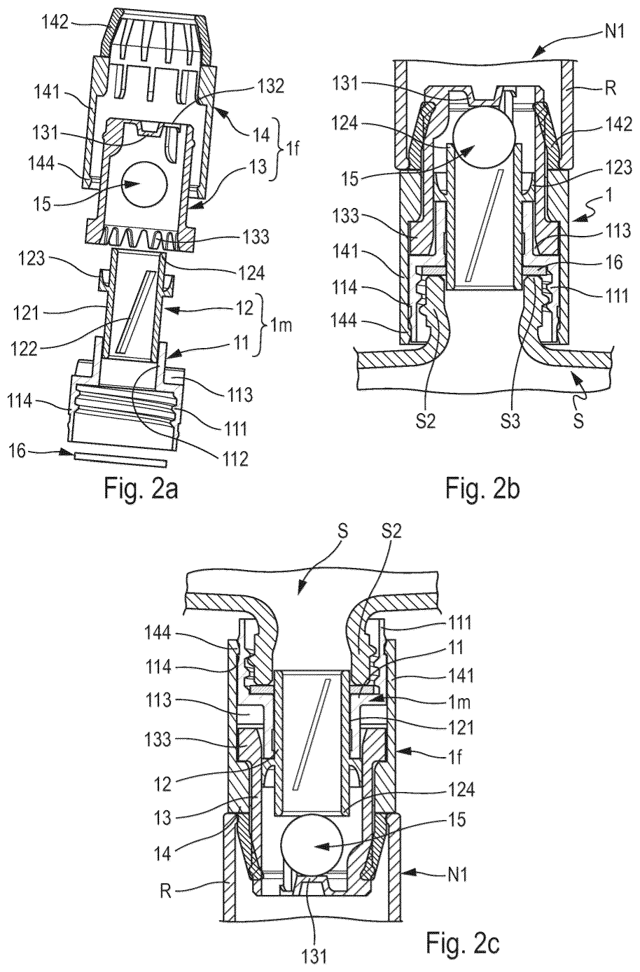

Reference is made to FIGS. 2a, 2b and 2c which show the filling and venting system 1 in the first embodiment of the invention. This filling and venting system 1 comprises a fixed part 1f and a movable part 1m, which cooperate between them, as will be seen below. The filling and venting system 1 also comprises a movable valve member 15, which here is in the form of a ball. Incidentally, the system 1 also comprises an annular flat seal 16 intended to seal on the upper annular edge S3 of the source bottle S.

The movable part 1m comprises two component parts 11 and 12, which are here made separately and added on one another, but they could also be made in one-piece. The moving part 1m comprises first of all, a mounting part 11, which forms a threaded sleeve 111, capable of engaging with the threaded neck S2 of the source bottle S. The thread of the threaded sleeve 111 is internal, since the thread of the threaded neck S2 is external. The threaded sleeve 111 externally forms a shoulder 114 facing downward. The mounting part 11 also comprises a chimney 112, which is substantially or perfectly cylindrical. At the junction between the threaded sleeve 111 and the chimney 112, the mounting part 11 forms a toothed plate 113. It can be said that this plate 113 extends above the threaded sleeve 111 around the chimney 112.

The movable part 1m also comprises a transfer part 12, which has a substantially cylindrical overall configuration, so as to be able to be engaged in a sealed sliding manner inside the chimney 111. The transfer part 12 internally defines a flow crossing duct 121, which is compartmentalised by a separating partition 122, which advantageously extends obliquely. Thus, the fluid product flows from one side of the partition 122, while the air flows on the other side in reverse flow. The cylinder 121 defines an upper annular edge 124, which serves as a valve seat for the ball 15, as will be seen below. The transfer part 12 also forms an annular lip 123, which projects radially outwards. In the final assembly position, the transfer part 12 is inserted into the chimney 122 with the lip 123 abutting on the upper edge of the chimney 112. This is shown in FIGS. 2b and 2c.

As mentioned above, it is possible to make the movable part M in one-piece by forming the duct 121 in the prolongation of the chimney 112.

The fixed part 1f also comprises two parts, namely a crown 13 and a cage 14. The crown 13 is securely engaged in the crown 14, so that it would eventually be possible to make these two parts in one-piece.

The crown 13 is generally cylindrical in configuration: however, its upper end is partially closed by a locking pin 131 that is surrounded by passage openings 132. At its lower end, the crown 13 forms a toothed collar 133, capable of interlocking intimately with the toothed plate 133 of the mounting part 11. In FIG. 2b, the teeth of the plate 113 and the collar 133 are interlocked, while in FIG. 2c, the teeth are disengaged and spaced apart. The engagement of the plate teeth 113 and the crown 133 has the function of leading the movable part 1m in rotation, when the “travel” dispenser N1 is screwed onto the threaded neck S2 of the source bottle S, as will be seen below. Another function of the crown 13 is to make a confined space for the movable valve member 15, which can come into sealed contact on the valve seat 124 formed at the upper end of the transfer part 12. In the closed position in FIG. 2b, the ball 15 is pressed onto its seat 124 by the locking pin 131. In FIG. 2c corresponding to an open position, the ball 15 is detached from the seat 124 and can rest on the pin 131.

The cage 14 serves as a container for the crown 13, but also for the movable part 1m. The cage 14 forms a skirt 141, the lower end of which forms an internal hooking profile 144. At its upper end, the cage 14 forms a dome 142 that has a dual function. The first function is to securely receive the crown 13. The second function is to make a solid and sealed fastener with the lower edge of the reservoir R, which is advantageously made in the form of a stretched glass tube. This is why the dome 142 may be overmoulded on the skirt 142 and formed from a flexible plastic material, such as an elastomer.

In FIG. 2b, corresponding to the closed position of the filling and venting system 1, the threaded sleeve 111 is entirely disposed inside the skirt 141. The internal hooking profile 141 is disposed axially below the internal shoulder 114. In FIG. 2c, corresponding to the open position of the filling and venting system 1, the threaded sleeve 111 projects out from the skirt 141 and the internal hooking profile 144 is engaged with the internal shoulder 114.

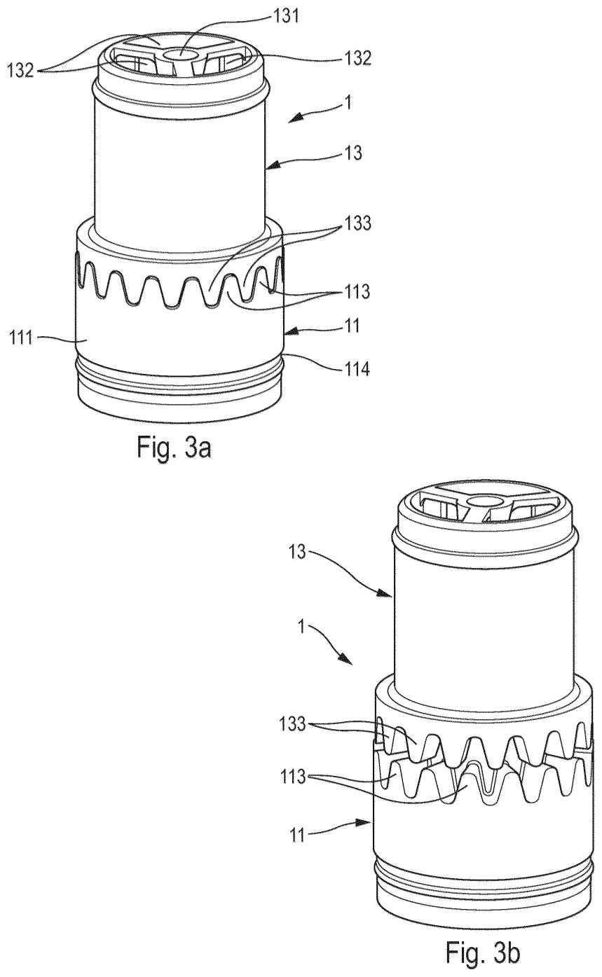

In FIGS. 3a and 3b show the filling and venting System 1, with the cage 14 removed. This clearly reveals the crown 13 and the mounting part 11. It is easier to notice the locking pin 131 which is surrounded by wide passage openings 132. The shoulder 114 can also be distinguished on the outer wall of the threaded sleeve 111. In FIG. 3a, the teeth of the plate 113 and of the collar 133 are intimately interlocked, so that the two parts 11 and 13 are integral in rotation. Conversely, in FIG. 3b, it can be noted that the teeth of the plate 113 and of the collar 133 are disengaged from or spaced apart from each another, so that the two parts are no longer integral in rotation. In other words, the crown 13 can be lead in rotation while leaving the mounting part 11 static. Returning briefly to FIGS. 2b and 2c, it can be understood that the filling and venting system 1 can be added and screwed onto the threaded neck S2 by means of the threaded sleeve 111. Once the connection is made, the filling and venting system 1 is still in the closed position. It can also be said that the movable valve member 15 and its valve seat 124 together form a controllable valve, which is locked in the closed position by the locking pin 131. To unlock the valve, all the user has to do is exert a traction on the “travel” dispenser N1, while holding the source bottle S with the other hand so as to move them apart. This has the effect of moving the movable part 1m inside of the cage 14. This axial movement has the effect of releasing the movable valve member 15, which can then detach itself from its seat 124. In addition, the teeth of the plate 113 and the collar 133 are disengaged, so that a rotation of the reservoir R does not lead to the unscrewing of the threaded sleeve 111 of the threaded neck S2. This decoupling between the fixed part 1f and the movable part 1m gives an assurance that the “travel” dispenser N1 cannot be unscrewed from the source bottle S when the valve is open.

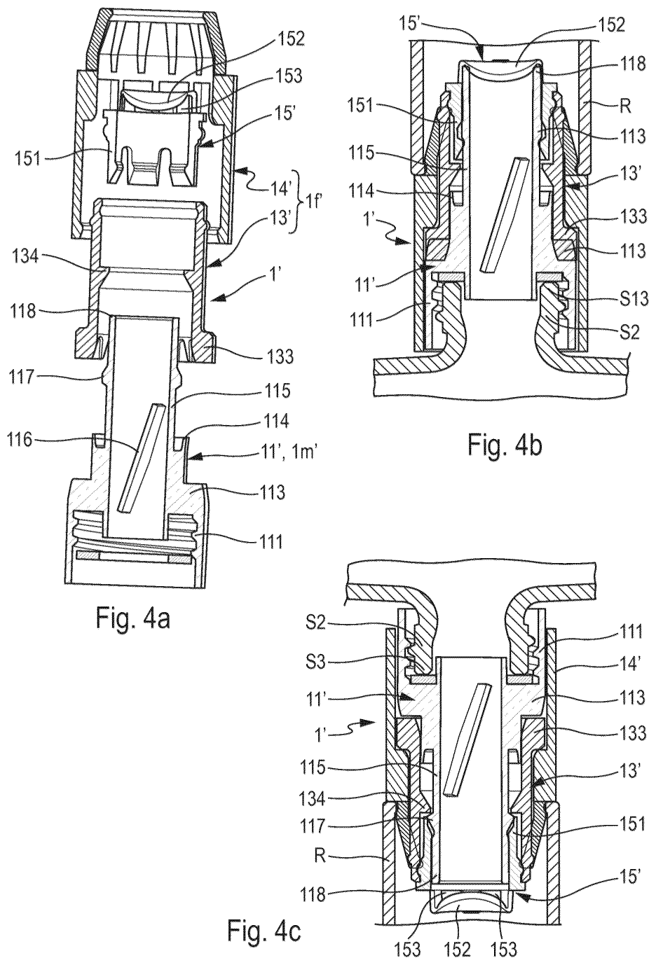

In reference to FIGS. 4a, 4b and 4c, a variant of the first embodiment of the invention is seen. Structural differences exist, but the operation is identical. This filling and venting system 1′ according to this variant also comprises a movable part 1m′ and a fixed part 1f′. The movable part 1m′ is here formed of a mounting and transfer part 11′, which is one-piece. This part 11′ forms a threaded sleeve 111, which may be identical to that of the first embodiment. The part 11′ also forms a toothed plate 113, which may be identical to that of the first embodiment. The part 11′ integrates here the flow crossing duct 115, which internally forms an oblique separating partition 116. The duct 115 externally forms an annular bead 117 and defines at its upper end a valve seat 118. An annular lip 114 is formed around the duct 115 in the axial extension of the toothed plate 113.

The fixed part 1f′ also comprises a crown 13′ and a cage 14′. The crown 13′ also comprises at its lower end a toothed collar 133, which may be identical or similar to that of the first embodiment. Internally, the crown 13 defines an inner shoulder 134.

The cage 14′ can be substantially identical to the cage 14 of the first embodiment.

In this filling and venting system 1′, the ball 15 has been replaced by a blocking member 15′, which is mounted securely inside the crown 13. To this end, the blocking member 15′ comprises a mount bushing 151, which is engaged securely and advantageously snap-fitted inside the crown 13. The blocking member 15′ also comprises a blocking cap 152, as well as the lateral passage openings 153.

In the closed and mounted position shown in FIG. 4b, it can be seen that the upper part of the duct 115 is engaged inside the mount bushing 151 with its upper annular edge 118 serving as a valve seat in sealed contact with the cap 152. Any passage of fluid is thus impossible. The flow crossing duct 115 is thus closed. It can also be noted that the teeth of the plate 113 and of the collar 133 are interlocked, as in the first embodiment.

In FIG. 4c, corresponding to the open position of the filling and venting system 1′, it can be noted that the cap 52 is arranged away from the valve seat 118, so that the fluid product can pass into the duct 115 through the lateral passage openings 153. As before, the teeth of the plate 113 and of the collar 133 are disengaged. A portion of the threaded sleeve 111 projects out from the cage 14′.

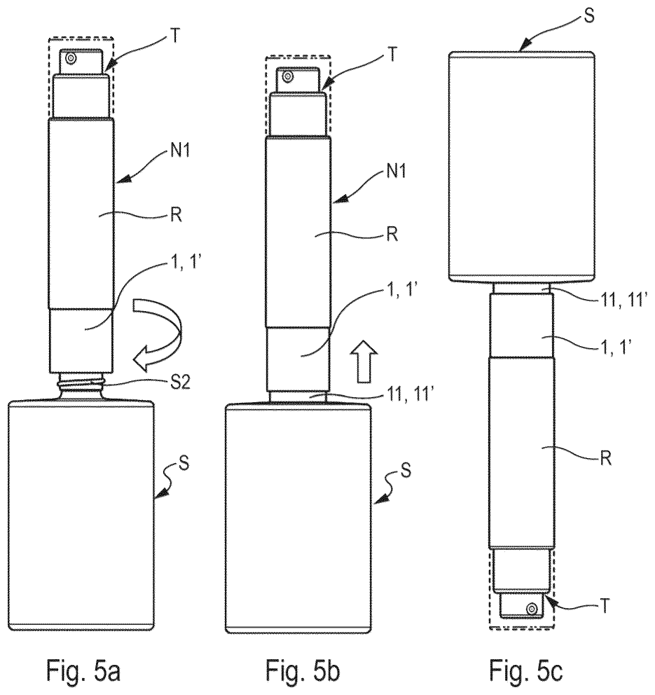

Reference can now be made to FIGS. 5a, 5b and 5c to describe a filling operation of the refillable dispenser N1 by means of the source S. After having removed the dispensing head S4 from the neck S2, the “travel” dispenser N1 can be added and mounted by screwing onto the neck S2. This is shown in FIG. 5a. The source bottle S can be held securely and the “travel” dispenser N1 can be lead in rotation, as indicated by the rounded arrow. As described above, the threaded sleeve 111 comes into threaded engagement with the threaded neck S2. Once the screwing has ended, the user can exert an axial traction in the direction of the arrow visible in FIG. 5b. All the user to do is to hold the bottle S with one hand and to grasp the reservoir R of the “travel” dispenser N1 to exert an axial traction away from the source S. This has the effect of opening the controllable valve integrated into the filling and venting system 1 or 1′. The fixed part 1f or 1f remains integral to the reservoir R, while the movable part 1m or 1m′ remains integral to the source bottle S. This axial traction has the effect of opening the valve, but also of disengaging the teeth of the plate 113 and of the collar 133, so that a rotational drive of the reservoir R no longer has the effect f unscrewing the threaded sleeve 111 from the neck S2. Consequently, the user can turnover the assembly to achieve the configuration shown in FIG. 5c. The fluid product stored in the source bottle S can then flow by gravity into the reservoir R through the filling and venting system 1 or 1′, which has been controlled in the open state. The fluid product can flow through the flow crossing duct on one side of the separating partition 122 or 116. Simultaneously, the air trapped in the reservoir R can flow or escape upward into the source bottle S through the filling and venting system 1, 1′, flowing into the flow crossing transfer duct on the other side of the partition. Filling ends, as soon as the level of fluid product reaches the open valve. There is enough air in the reservoir of the “travel” dispenser to absorb the pressure or temperature variations. The valve can then immediately be closed by pressing on the travel dispenser towards the source bottle. Alternatively, in the case of the first embodiment, the assembly can be turned over to put the travel dispenser N1 back above the source bottle S. By doing so, the ball 15 will return to its seat 124 by gravity and close the duct 121, even before closing the valve by pressing on the travel dispenser N1 towards the source bottle S.

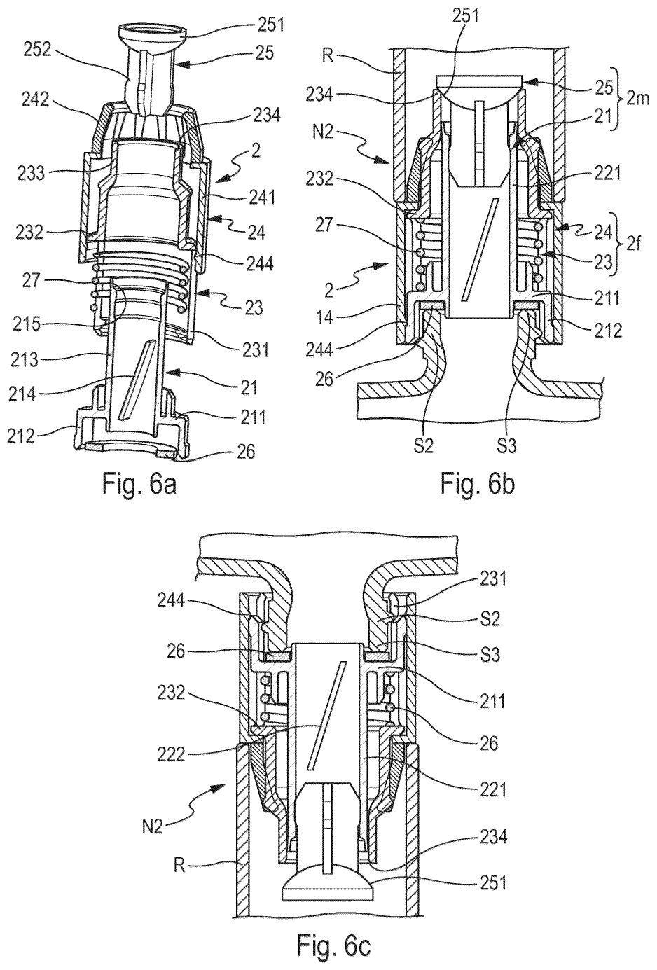

FIGS. 6a, 6b and 6c show a filling and venting system 2 according to a second embodiment of the invention. As in the first embodiment, this filling and venting system 2 also comprises a fixed part 2f and a movable part 2m. The mutual movement of these two parts 2f and 2m has the same purpose as in the first embodiment, namely the opening and closing of the valve integrated into the filling and venting system 2. However, unlike the first embodiment, in which the valve opens as a result of traction exerted by the user, in this second embodiment, the valve opens automatically when the filling and venting system 2 is screwed onto the source bottle S.

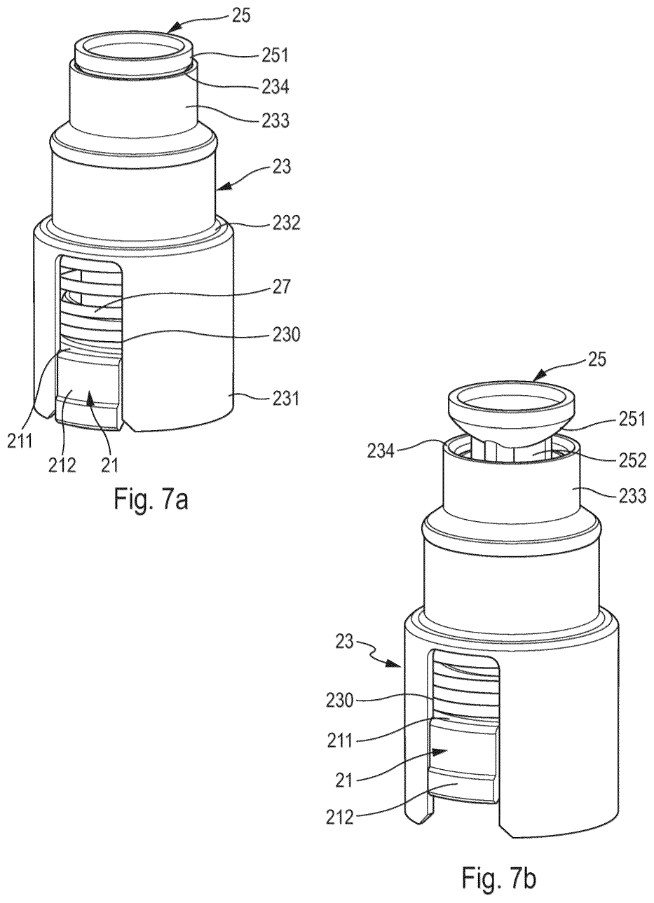

The fixed part 2f comprises two parts, namely a mounting part 23 and a cage 24. The cage 24 can be substantially similar or identical to that of the first embodiment. As for the mounting part 23, it comprises, as in the first embodiment, a threaded sleeve 231 intended to engage with the threaded neck S2 of the source bottle S. This mounting part 23 generally defines a cylindrical, slightly frustoconical configuration. The threaded sleeve 231 is located at the lower portion of the mounting part 23. The threaded sleeve 231 is provided with two indentations 230, more visible in FIGS. 7a and 7b. At its opposite end, the mounting part 11 forms a sliding barrel 231, which ends in an annular upper edge acting as a valve seat 234. Externally, the mounting part 11 forms an annular bearing shoulder 231. The mounting part 11 is securely received inside the cage 24, which itself is securely and sealingly received inside a lower opening of the reservoir R, which can also be made in the form of a stretched glass tube. Without going into detail, the cage 24 comprises a skirt 241, which internally forms an abutment profile 244. As for the cap 242, it may be made by overmoulding from a flexible plastic material, such as an elastomer.

The movable part 2m also comprises two parts, namely a transfer part 21 and a movable valve member 25. These two parts are securely connected to one another, so that they could be made as a one-piece.

The transfer part 21 comprises an annular plate 211, under which an annular seal 26 is arranged. Two axial tabs 212, arranged in a diametrically opposite manner, extend downward from the outer periphery of the annular plate 211. These tabs 212 are captive to the indentations 230, as can be seen in FIGS. 7a and 7b. The transfer part 21 also forms a fluid crossing duct 213, in which there extends a separating s partition 214. At its upper end, the duct 213 forms a lip 215.

The filling and venting system 2 also comprises a spring 27, which is arranged inside the threaded sleeve 231 and which bears against the shoulder 232. On the opposite side, the spring 27 bears on the annular plate 211 of the transfer part 21.

The movable valve member 25 comprises a corolla 25, as well as an anchoring stub 252, which is received in a secured manner inside the flow crossing duct 213, as can be seen in FIGS. 6b and 6c.

In the closed position of the valve of the filling and venting system 2, the corolla 251 rests sealingly on the valve seat 234 formed by the crown 23. The spring 27 is compressed between the shoulder 232 and the plate 211, so that the corolla 251 is pressed strongly against the seat 234. The tabs 212 of the transfer part 21 are received inside the cage 14 and in indentations 230 of the threaded sleeve 231, as can be seen in FIGS. 7a and 7b. The lip 215 of the duct 213 is engaged in a sealed sliding manner in the barrel 233 of the mounting part 23.

In FIG. 6c, representing the valve in the open state, it can be seen that the threaded sleeve 231 is now fully screwed onto the threaded neck S2 of the source bottle, which has caused an axial movement of the transfer part 23, the plate 211 of which is pressed against the upper annular edge S3 of the source bottle S, with the interposition of the seal 26. The axial movement of this transfer part 21 has the consequence of compressing the return spring 27 and of detaching the corolla 251 from its seat 234. The valve is then open.

It should be noted that in this second embodiment, the valve opens automatically when the sleeve 231 is screwed onto the threaded neck S2. In other words, the actuation of the controllable valve is induced by the operation of screwing/unscrewing the sleeve 231 on the threaded neck S2. On the other hand, it can be noted that the seal between the refillable dispenser N2 and the source bottle S occurs at the very beginning of screwing, given that the seal 26 is compressed on the annular upper edge S3 of the neck S2 by the plate 211 of the transfer part 21. Thus, the risks of leakage are reduced to a minimum.

In FIGS. 7a and 7b, it can be seen more precisely, that the threaded sleeve 231 is formed with two wide indentations 230 that extend over almost its entire height until it is close to the shoulder 232. The tabs 212 are inscribed inside these indentations 230 and can move, as explained above, axially by sliding with compression of the return spring 27. In FIG. 7a, the valve is in the rest position and abuts against the fastening profiles 244 of the cage, as can be seen in FIG. 6b. In FIG. 7b, the valve is open and the tabs 212 have been moved axially upward inside the indentations 230 by the plate 211 pressing on the upper annular edge S3 of the neck S2. The tabs 212 are then snap-fitted above the hooking profiles 244, as can be seen in FIG. 6c. This snap-fitting may generate a noise, such as a “click”, which indicates to the user that the valve is in the open position.

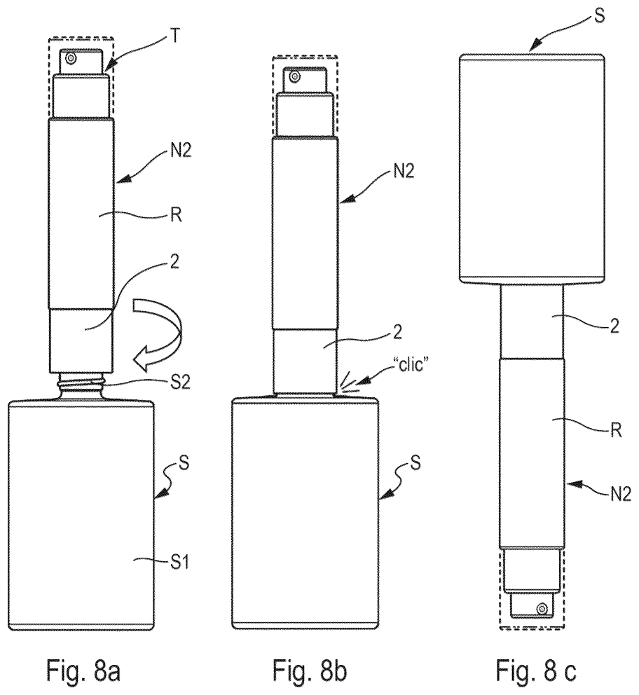

With reference to FIGS. 8a, 8b and 8c, the different steps of a filling operation of the “travel” refillable dispenser N2 can be seen. In FIG. 8a, the refillable dispenser N2 is added to the source bottle S and it can be screwed by driving the “travel” dispenser in rotation relative to the bottle S. As explained previously, the threaded sleeve 231 comes into threaded engagement with the threaded neck S2. At the end of screwing, as shown in FIG. 8b, the tabs 212 snap-fit on to the other side of the hooking profile 244 of the cage 24, generating a small click, indicating to the user that the screwing is finished. All the user has to do is turn the assembly upside down, as shown in FIG. 8c. The fluid product from the source bottle S then flows by gravity into the reservoir R of the refillable dispenser N2, passing through the flow crossing duct 213 on one side of the separating partition 214. At the same time, the air contained in the reservoir R can be evacuated upward into the source bottle S through the duct 213 on the other side of the partition 214.

Once the refillable dispenser N2 has been filled, simply turnover the assembly and unscrew the dispenser from the source bottle S. Finally, the user can optionally reassemble the dispenser head S4 onto the threaded neck S2.

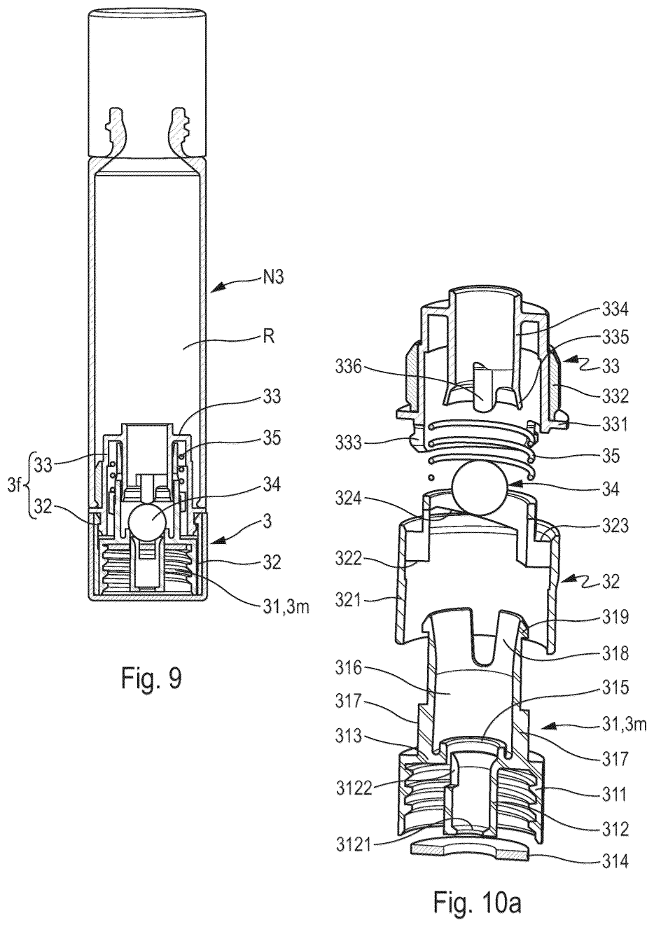

FIG. 9 shows a refillable or “travel” dispenser N3 according to a third embodiment of the invention, which integrates a filling and venting system 3, which performs substantially the same functions as the previously described systems. The “travel” dispenser N3 is shown here without a pump mounted on its neck, but it must be understood that it actually integrates a pump, as in the two preceding embodiments. The filling and venting system 3 is mounted in a fixed and sealed manner at the lower end of the reservoir R, which can be formed from a glass tube. As in the previous embodiments, the filling and venting system 3 is permanently mounted at the lower end of the reservoir R: any dismounting is impossible. Very generally, the filling and venting system 3 comprises, as in the two preceding embodiments, a fixed part 3f and a movable part 31 or 3m. The fixed part 3f comprises two parts 32 and 33 which are mounted on one another to form a unitary assembly. The filling and venting system 3 also comprises a ball 34, acting as a movable valve member, and a spring 35 which acts between the fixed part 3f and the movable part or part 31 or 3m. The filling and venting system 3 integrates a controllable valve.

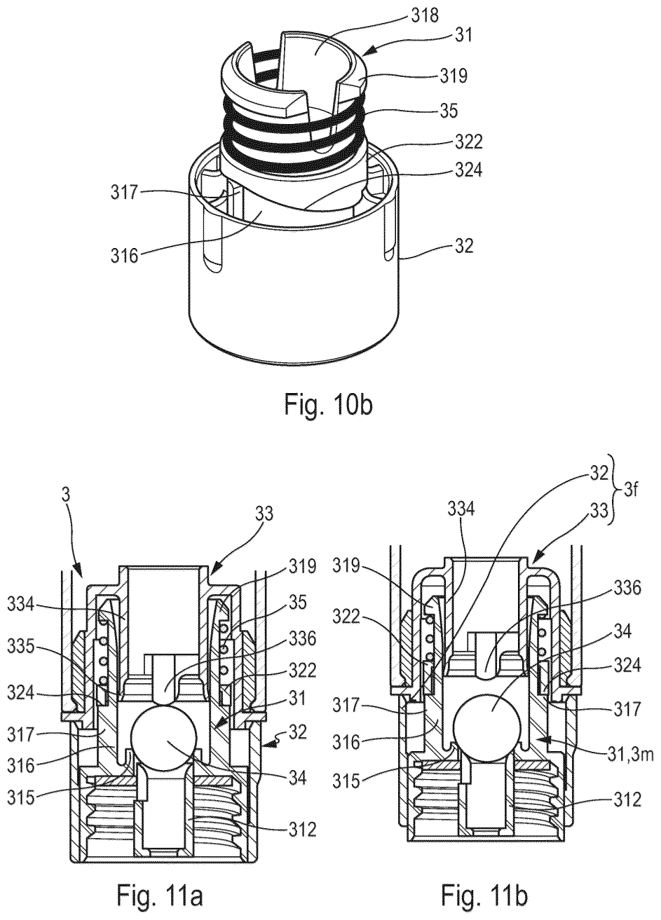

Reference will now be made to FIGS. 10a and 10b to describe in detail the structure of the filling and venting system 3 according to this third embodiment of the invention. The mobile part 31 or 3m is preferably made as a one-piece by injection of plastic material. First of all, this movable part 31 forms a threaded sleeve 311, intended to come into threaded engagement with the threaded neck of a source bottle. The movable part 31 also forms an inlet pipe 312 that extends coaxially inside the threaded sleeve 311. This inlet pipe 312 comprises an axial opening 3121 as well as a lateral opening 3122. The threaded sleeve 311 is connected to the inlet pipe 312 by an annular plate 313. A neck seal 314 is inserted inside the threaded sleeve 311 around the inlet pipe 312 to come into contact with the lower face of the annular plate 313. The plate 313 forms an annular valve seat 315, which is in the form of an annular flange that projects upward from the inner periphery of the plate 313. This valve seat 315 surrounds the upper end of the inlet pipe 312. It can even be noted that the lateral opening 3122 is located close to the valve seat 315. The movable part 31 also forms a sliding barrel 316 that extends upward from the annular plate 313. The sliding barrel 316 is coaxial and extends outside of the valve seat 315. Externally, the sliding barrel 316 is provided with axial or vertical ribs 317 that extend from the plate 313 upward. By way of example, it is possible to provide two ribs 317 located in diametrically opposite manner. The sliding barrel 316 extends upward by several tabs or flexible sectors 318 which externally form hooking profiles 319.

As previously mentioned, the fixed part 3f comprises two separate parts 32 and 33 securely added on one another The first fixed part 32 comprises a substantially cylindrical skirt 321, which comes to surround the threaded sleeve 311 of the movable part 31. At its upper end, the skirt 321 is connected to an inner crown 322 that forms axial snap-fitting housings 323. The crown 322 also forms one or more inclined helical ramps 324 that are oriented downward. By way of example, two ramps 324 can be provided.

The second fixed part 33 comprises an annular collar 331 that projects radially outwards and that is intended to come bearing on the crown 322. The second fixed part 33 also comprises snap-fitting sectors 333 intended to come into snap-fitted engagement with the snap-fitting housings 323. Externally, the fixed part 33 is provided with a sealing trim 332 intended to come into tight sealing contact inside the reservoir R. The second fixed part 33 also forms a lip duct 334 which forms at its lower end, an annular lip 335 intended to come into sealed sliding contact inside the sliding barrel 316. The lip duct 334 internally forms a thrust pin 336, which is oriented downward. The filling and venting system 3 also comprises a ball 34 and a spring 35, the functions of which will be explained in more details below. The ball 34 bearing selectively on its seat 315 forms a controllable valve, the handling of which will be described below.

In FIG. 10b, the first fixed part 32 is shown mounted on the movable part 31. The skirt 321 surrounds the threaded sleeve 311 as well as a portion of the sliding barrel 316, which is partially visible below the inclined helical ramp 324. It can also be noted that the upper end of the vertical rib 317 that comes into contact with the ramp 324. The spring 35 is arranged around the flexible tabs 318 and bears, on the one hand, on the top of the crown 322 and, on the other hand, below the hooking profiles 319. The spring 35 thus urges the hooking profiles 319 away from the crown 322. As a result, the upper end of the vertical rib 317 is urged against the inclined helical ramp 324. In FIG. 10b, the rib 317 is located at the highest level of the ramp 324, so that the hooking profiles 319 are in the furthest position relative to the crown 322. It is readily understood that a counter-clockwise rotation of the fixed part 32 around the movable part 31 has the effect of moving the rib 317 along the inclined ramp 324, causing the hooking profiles 319 to move closer to the crown 322.

In FIG. 11a, the filling and venting system 3 is shown in its closed position. The spring 35 is relaxed. The hooking profiles 319 are in their furthest position from the crown 322. The sealing lip 335 that leads the lip 334 is pushed in to the maximum inside the sliding barrel 316. The thrust pin 336 is in contact with the ball 34, which is thus pushed onto its valve seat 315. The ribs 317 are in the position shown in FIG. 10a. In this closed position, there can be no fluid communication between the inlet pipe 312 and the lip duct 334, given that the ball 34, acting as a movable valve member, is pressed by the pin 336 against its seat 315.

In FIG. 11b, the movable part 31 or 3m has been moved relative to the fixed part 3f. This relative axial movement was generated by the relative rotation between the movable parts 3m and fixed 3f parts. During this relative rotation, the ribs 317 have been moved along the inclined helical ramps 324, from the closed position shown in FIG. 10b to an open position, in which the ribs 317 are then positioned at the other end of the ramps 324. The movement of the ribs 317, which act as a cam, has the effect of bringing the hooking profiles 319 closer to the crown 322. The spring 35 is then compressed. The lip duct 334 has moved in the sliding barrel 316 and the thrust pin 336 has detached itself from the ball 34, which rests in an unstressed manner on its seat 315. It is readily understood that a flow of fluid product coming from the inlet pipe 312 will detach the ball 34 from its seat 315 so as to be able to flow through the lip duct 334.

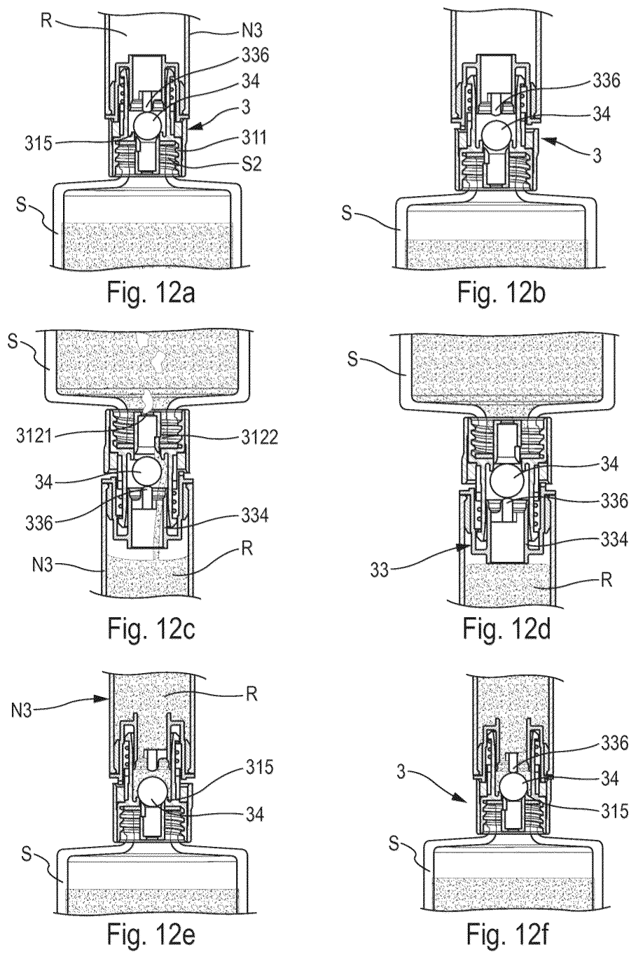

Reference will now be made to FIGS. 12a to 12f to describe a complete operation of filling the “travel” dispenser N3 from a source bottle S, through the filling and venting system 3 according to this third embodiment of the invention. In FIG. 12a, the threaded sleeve 311 is already screwed around the threaded neck S2 of the source bottle S. However, the filling and venting system 3 is still in its closed position shown in FIG. 11a. The ball 34 is pushed against its seat 315 by the pin 336. To achieve this configuration, the user simply has to lead the refillable dispenser R in rotation on the threaded neck S2 of the source bottle.

By continuing the rotation on the refillable dispenser R, the configuration shown in FIG. 12b is reached. The system 3 is then in the open configuration shown in FIG. 11b. The pin 36 is detached from the ball 34.

The user can then turnover the source bottle S, with the “travel” dispenser N3 mounted on it, to achieve the configuration of FIG. 12c. The fluid product stored in the source bottle S then flows by gravity through the lateral opening 3122 of the inlet pipe 312 to reach the ball 34, which is then detached from its seat and rests in an unstable and unsealed manner on the pin 336. The fluid product can then flow through the lip duct 334 to reach the reservoir R of the “travel” dispenser N3. At the same time, air from the reservoir R of the “travel” dispenser N3 can escape through the lip duct 334 and the axial opening 3121 of the inlet pipe 312.

The filling of the reservoir R ends as soon as the liquid level reaches the inlet of the lip duct 334. A little air remains around the second fixed part 33. This is then the configuration of FIG. 12d.

The user can then turn the source bottle S upside down again to the achieve the configuration shown in FIG. 12e. The reservoir R of the “travel” dispenser N3 is filled with fluid product and a little air, but it cannot flow back into the source bottle S, given that the ball 34 rests sealingly by gravity on its seat 315.

It is then a simple matter of closing the controllable valve of the filling and venting system 3 by rotating the “travel” dispenser N3 on the source bottle S. This leads to the configuration shown in FIG. 12f, which corresponds to the closed configuration of FIG. 11b.

The user can unscrew the threaded sleeve 31 from the threaded neck S2 of the source bottle to separate the “travel”dispenser N3 from the source bottle S.

In summary, the “travel” dispenser N3 is first screwed onto the neck S2 of the source bottle S by means of the threaded sleeve 311. Then, the controllable valve 34, 315 of the filling and venting system 3 is opened by continuing the screwing operation. Once the reservoir is filled, a rotation in the opposite direction closes the controllable valve. Finally, the “travel” dispenser N3 is unscrewed from the source bottle S. This sequence of operations, namely screwing/opening/closing/unscrewing, is imposed by a torque peak resulting from the crushing of the neck seal 314, combined with a screwing torque which is less than the opening torque. Thus, it is guaranteed that the screwing phase takes place before the opening phase and that the closing phase takes place before the unscrewing phase. More precisely, at the end of screwing, the upper edge of the threaded neck S2 of the source bottle S comes into contact with the neck seal 314. This axial contact generates a torque peak, which of course immobilises the sleeve 31 relative to the neck S2 and triggers the opening of the controllable valve. The same applies symmetrically when closing and unscrewing. The unscrewing torque is less than the torque peak generated by the compression of the neck seal 314, so that the controllable valve is closed before unscrewing.

In this third embodiment, the controllable valve is opened in the continuity of the screwing of the threaded sleeve 311 on the threaded neck S2 of the source bottle S and the controllable valve is closed before the unscrewing operation. For the user, the opening and closing of the controllable valve is imperceptible.

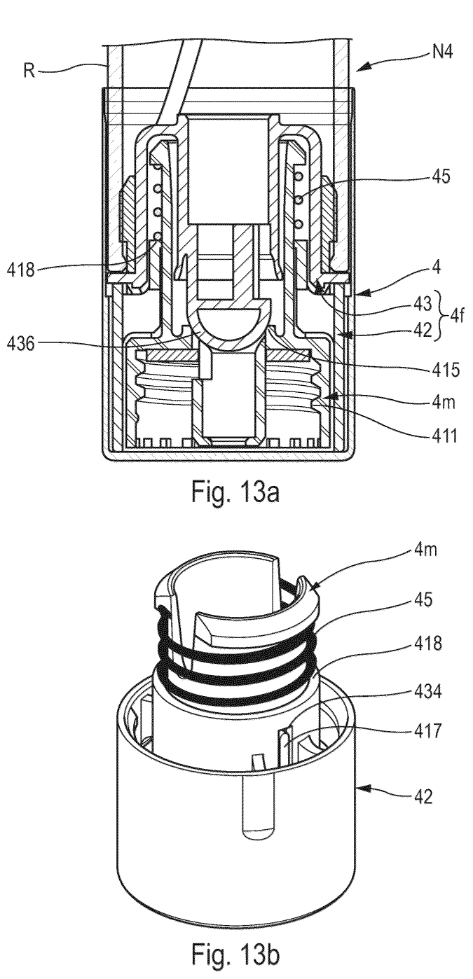

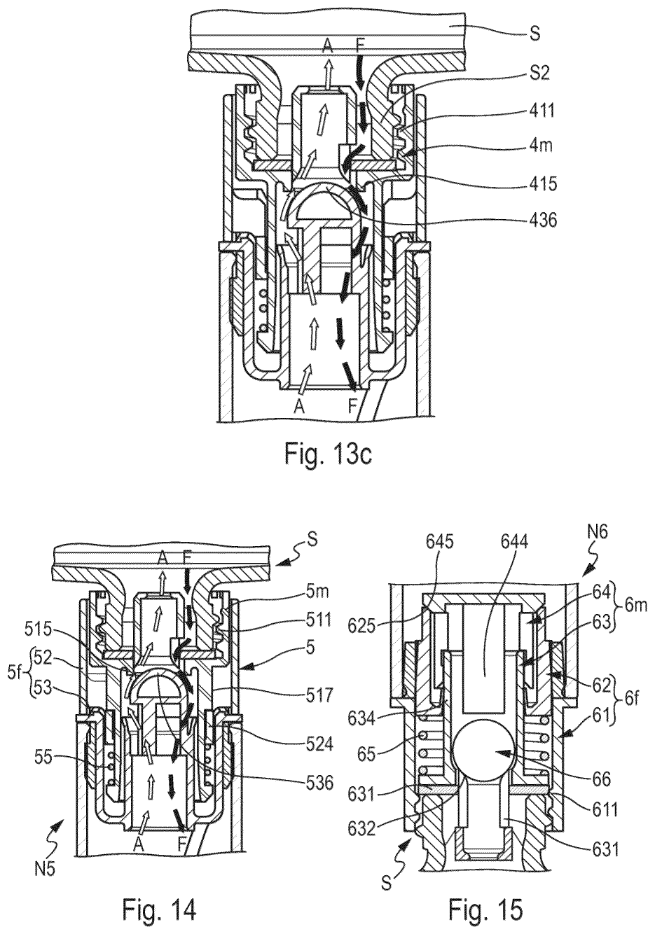

FIGS. 13a, 13b and 13c illustrate a fourth embodiment of the invention, which integrates a filling and venting system 4, which performs substantially, the same functions as the systems previously described. Only the lower part of the “travel” dispenser N4 is shown here, but it must be understood that it actually integrates a pump, as in the other preceding embodiments. The filling and venting system 4 generally adopts the design of the filling and venting system 3 of the third embodiment, except for the ball 34 and the ramps 324. The filling and venting system 4 is mounted in a fixed and sealed manner at the lower end of the reservoir, which can be formed from a glass tube. As in the previous embodiments, the filling and venting system 4 is permanently mounted at the lower end of the reservoir R: any dismounting is impossible. Very generally, the filling and venting system 4 comprises, as in the previous embodiments, a fixed part 4f and a movable part 4m. The fixed part 4f comprises two parts 42 and 43, which are mounted on one another to form a unitary assembly. The filling and venting system 4 also comprises a spring 45 which acts between the fixed part 4f and the movable part 4m. The filling and venting system 4 integrates a manually actuated controllable valve, here by traction.

The movable part 4m can comprise the same features as the movable part 3m of the third embodiment, including the ribs 317, referenced 417 in this fourth embodiment. The movable part 4m forms, among other things, the threaded sleeve 411 and the valve seat 415.

The fixed part 4f can comprise the same features as the fixed part 3f of the third embodiment, with the exception of the ramps 324 and the thrust pin 336. Instead of the ramps 324, the fixed part 4f forms longitudinal slots 434, in which the ribs 417 are engaged in a sliding manner The fixed part 4f also comprises two separate parts 42 and 43 securely added on one another. The first fixed part 42 defines an upper annular edge 418, on which a spring 45 bears. The second fixed part 43 forms a valve member 436 instead of the thrust pin 336.

Thus, a complete filling operation of the travel dispenser N4 from a source bottle S, through the filling and venting system 4 according to this fourth embodiment of the invention takes place as follows:
Screwing the threaded sleeve 411 of the threaded neck S2 of the source bottle S,
Turning over of the assembly thus formed, to arrange the source bottle(S) above the dispenser N4,
Traction exerted on the dispenser N4 while holding the source bottle S, causing the opening of the controllable valve (valve member 436 detached from its seat 415),
Filling the reservoir R of the dispenser N4 and evacuating the air in the source bottle S (arrows A and F in FIG. 13c),
Release of the traction exerted on the dispenser N4, causing the closure of the controllable valve under the action of the spring 45,
Turning over the assembly thus formed, to once again place the dispenser N4 above the source bottle S,
Unscrewing the threaded sleeve 411.

With this dispenser N4, the user can easily control the filling level of the reservoir R, by releasing the traction at the desired time.

FIG. 14 illustrates a fifth embodiment of the invention, which integrates a filling and venting system 5, which performs substantially, the same functions as the systems previously described. The filling and venting system 5 generally adopts the design of the filling and venting system 3 of the third embodiment, except for the ball 34. The cam system with ramps 324 and ribs 317 has also been adopted, but with some adaptations so that it automatically returns its starting position.

Very generally, the filling and venting system 5 comprises, as in the previous embodiments, a fixed part 5f and a movable part 5m. The fixed part 5f comprises two parts 52 and 53, which are mounted on one another to form a unitary assembly. The filling and venting system 5 also comprises a spring 55 which acts between the fixed part 5f and the movable part 5m. The filling and venting system 5 integrates a manually actuated controllable valve, here by rotation or screwing.

The movable part 5m can comprise the same features as the movable part 3m of the third embodiment, including the ribs 517.

The fixed part 5f can comprise the same features as the fixed part 3f of the third embodiment, including the ramps 324, but with the valve member 436 of the fourth embodiment instead of the thrust pin 336 of the third embodiment.

The fixed part 5falso comprises two separate parts 52 and 53 securely added on one another. The first fixed part 52 defines the ramps 524 and the second fixed part 53 forms the valve member 536.

A spring 55 acts between the movable part 5m and the first fixed part 52, as in the third embodiment.

The movable part 5m can thus rotate relative to the fixed part 5f, after the sleeve 511 has been screwed onto the threaded neck of the source bottle S, by exerting an opening torque, which makes it possible to slide the ribs 517 along the ramps 524.

The particularity of this fifth embodiment resides in the fact that the slope of the ramps 524 and the stiffness of the spring 55 have been determined in such a way that the ribs 517 automatically slide back under the ramps 524 as soon as the torque is released. In other words, as in the fourth embodiment, the return of the controllable valve to the closed position takes place automatically as soon as the user releases the torque. It is therefore, not necessary to unscrew manually to close the controllable valve.

Thus, a complete filling operation of the travel dispenser N5 from a source bottle S, through the filling and venting system 5 according to this fifth embodiment of the invention takes place as follows:
Screwing the threaded sleeve 511 of the threaded neck S2 of the source bottle s,
Turning over the assembly thus formed, to arrange the source bottle S above the dispenser N5,
Opening torque exerted between the dispenser N5 and the source bottle S, causing the opening of the controllable valve,
Holding the opening torque during filling of the reservoir R of the dispenser N5,
Release of the screwing torque, causing the closure of the controllable valve under the action of the spring 55,
Turning over the assembly thus formed, to once again place the dispenser N5 above the source bottle S,
Unscrewing the threaded sleeve 511.

With this dispenser N5, the user can easily control the filling level of the reservoir R, by releasing the torque at the desired moment.

With reference to FIG. 15, a sixth embodiment for a travel dispenser N6 will be briefly described. Very generally, the filling and venting system 6 comprises, as in the previous embodiments, a fixed part 6f and a movable part 6m. The fixed part 6f comprises two fixed parts 61 and 62, which are mounted on one another to form a unitary assembly. The movable part 6m comprises two movable parts 63 and 64, which are mounted on one another to form a unitary assembly, by trapping a ball 65 between them. The filling and venting system 6 also comprises a spring 65, which acts between the fixed part 6f and the movable part 6m. The filling and venting system 6 integrates a manually actuated controllable main valve, here by rotation, and a temporary free-ball valve.

The first fixed part 61 forms a threaded sleeve 611 to screw onto the threaded neck S2 of the source bottle S. The second fixed part 62 forms a main valve seat 625.

The first movable part 63 forms a bearing collar 631 intended to come into abutment on the upper edge of the threaded neck S2, with a neck seal possibly interposed. The first movable part 63 also forms a pipe 631 that penetrates into the threaded neck S2, a temporary valve seat 632 and a chimney 634. The ball 65 is housed in the chimney 634 and rests by gravity on the temporary valve seat 632, when the dispenser N6 is in the upright position, as can be seen in FIG. 15.

The second movable formed part 64 is securely mounted around the chimney 634 and comprises a pin 644 engaged in the chimney to limit the freedom of the ball 65, which can still move freely by gravity. Since the movable parts 63 and 64 are fixed relative to one another, the ball is never blocked: it can move freely in a restricted space delimited by the temporary valve seat 632 and the pin 644. The second movable part 64 also forms a main valve member 645, capable of coming into sealed contact with the main valve seat 625, under the action of the spring 65.

Thus, a complete filling operation of the travel dispenser N6 from a source bottle S, through the filling and venting system 6 according to this fifth embodiment of the invention takes place as follows:
Screwing the threaded sleeve 611 of the threaded neck S2 of the source bottle S, causing the controllable main valve to open,
Turning over of the assembly thus formed, to arrange the source bottle S above the dispenser N6,
Filling of the reservoir of the N6 dispenser by gravity,
Turning over of the assembly thus formed, to once again place the dispenser N6 above the source bottle S, causing the closure of the temporary valve (ball 65 bearing on its seat 632,
Unscrewing of the threaded sleeve 611, causing the controllable main valve to close,

With this dispenser N6, the controllable main valve is separated from the temporary valve, which only performs its function after the second turning over and before unscrewing.

In the six embodiments, including in the variant of the first embodiment, the “travel” refillable dispenser integrates a filling and venting System comprising a threaded sleeve intended to be screwed directly onto the threaded neck S2 of the source bottle S, which is preferably made in one-piece, for example made of glass.

The filling and venting systems integrate a controlled valve, the opening of which is generated by an action of the user, namely a traction without elastic return stress in the first embodiment, a traction with automatic return to the closed position by elastic stress in the fourth embodiment, the simple screwing under elastic stress in the second and sixth embodiments, an actuation screwing under elastic stress that follows or precedes the screwing onto the neck of the source bottle in the third embodiment and finally an actuation screwing with automatic return to the closed position by elastic stress in the fifth embodiment.

It should be noted that these different gravity filling and venting systems, and more particularly, their controllable valves, can be implemented without the threaded sleeve intended to be screwed directly onto the threaded neck S2 of the source bottle S. In other words, an independent protection could be sought for a refillable dispenser comprising a dispensing head, a reservoir and a gravity filling and venting system integrating a controllable valve which is manually actuated, by an axial movement caused by a traction or rotation, between a closed state and an open state.

1. : An assembly comprising a source bottle and a refillable dispenser,
the source bottle, advantageously made of glass, comprising a body containing a fluid product and a threaded neck made in one-piece with the body,
the refillable dispenser defining a longitudinal axis and comprising at an upper end a dispensing head provided with a push-button and at a lower end a filling and venting system, the refillable dispenser comprising a reservoir in communication with both the dispensing head and the filling and venting system,
characterised in that the refillable dispenser integrates a threaded sleeve capable of screwing onto the threaded neck of the source bottle, the filling and venting system then being connected to the body, so that the fluid product from the source bottle can flow by gravity from the source bottle into the reservoir through the filling and venting system, while the air from the reservoir can flow simultaneously from the reservoir into the source bottle through the filling and venting system.

2. : The dispensing assembly according to claim 1, wherein the threaded sleeve is permanently connected to the refillable dispenser, so that it is inseparable from it, the threaded sleeve advantageously being an integral and inseparable part of the filling and venting system which is permanently mounted on the reservoir.

3. : The dispensing assembly according to claim 1, wherein the filling and venting system comprises a controllable valve, which is manually actuated, by an axial movement along the longitudinal axis caused by a traction or a rotation, between a closed state and an open state, the controllable valve comprising a valve seat and a valve member the valve, the valve seat being integral in movement with the threaded sleeve.

4. The dispensing assembly according to claim 3, wherein the filling and venting system comprises a fixed part mounted on the reservoir and a movable part capable to move axially relative to the fixed part over a determined axial travel, generating the opening, respectively the closing, of the controllable valve.

5. : The dispensing assembly according to claim 4, wherein the threaded sleeve is formed by the movable part, the valve member being a free member, such as a ball, which is pressed against the valve seat by the fixed part in the closed state and which is free to detach from the valve seat in the open position.

6. : The dispensing assembly according to claim 5, wherein the fixed part and the movable part are rotatable relative on one another, the fixed part and the movable part together defining a cam system capable of generating a relative axial movement along the longitudinal axis of the fixed part relative to the movable part by the relative rotation of the fixed part relative to the movable part.

7. : The dispensing assembly according to claim 6, wherein the cam system comprises an inclined helical ramp formed by one of the fixed part and the movable part and a cam formed by the other of the fixed part and the movable part, the cam sliding along the inclined helical ramp during the relative rotation of the fixed part relative to the movable part.

8. : The dispenser assembly according to claim 6, wherein a spring acts between the fixed part and the movable part so as to urge the fixed part towards the movable valve member so as to press it against its valve seat, the cam system, in a direction of rotation, moving the fixed part away from the valve member so that it can be detached from its valve seat.

9. : The dispensing assembly according to claim 1, wherein the threaded sleeve and the valve seat are formed by the movable part, the valve member is formed by the fixed part, a spring acting between the fixed part and the movable part so as to urge the valve member towards the valve seat, the fixed part and the movable part being movable against the spring by a traction along the longitudinal axis to detach the movable member from the valve seat and thus, bring the controllable valve into the open position, the spring automatically returning the controllable valve into the closed position, as soon as the traction is released.

10. : The dispensing assembly according to claim 1, wherein the threaded sleeve and the valve seat are formed by the movable part, the valve member is formed by the fixed part, a spring acting between the fixed part and the movable part so as to urge the valve member towards the valve seat, the fixed part and the movable part together defining a cam system capable of generating a relative axial movement along the longitudinal axis of the fixed part relative to the movable part by the relative rotation of the fixed part relative to the movable part, the fixed part and the movable part being movable against the spring by an opening torque to detach the movable member from the valve seat and thus, bring the controllable valve into the open position, the spring automatically returning the controllable valve to the closed position, as soon as the opening torque is released.

11. : The dispensing assembly according to claim 1, wherein the movable part also forms an inlet pipe upstream of the valve seat inside the threaded sleeve, the inlet pipe forming an axial opening and a lateral opening, the lateral opening advantageously being located close to the valve seat.

12. : The dispensing assembly according to claim 1, wherein the threaded sleeve and the valve seat are formed by the fixed part the valve member is formed by the movable part, a spring acting between the fixed part and the movable part so as to urge the valve member towards the valve seat, the fixed part and the movable part being movable against the spring by screwing the threaded sleeve onto the threaded neck of the source bottle to detach the movable member from the valve seat and thus, bring the controllable valve into the open position, the movable part advantageously integrating a ball valve comprising a ball seat and a ball which moves freely by gravity, the ball resting on its ball seat, when the refillable dispenser is in the upright position.

13. : A method for filling a refillable dispenser by means of a source bottle, the source bottle, advantageously made of glass, comprising a body containing a fluid product and a threaded neck made in one-piece with the body, the source bottle being provided with a dispensing head removably screwed onto the threaded neck,
the refillable dispenser defining a longitudinal axis and comprising at an upper end a dispensing head provided with a push-button and at a lower end a filling and venting system the refillable dispenser comprising a reservoir in communication both with the dispensing head and the filling and venting system, the refillable dispenser integrating a threaded sleeve capable of screwing onto the threaded neck of the source bottle,
the filling method comprising the following successive steps:
unscrew the dispenser head from the threaded neck,
screw the refillable dispenser onto the threaded neck,
turnover the assembly thus formed, to arrange the source bottle above the refillable dispenser,
let the fluid product from the source bottle flow by gravity into the reservoir through the filling and venting system, and let the air from the reservoir flow simultaneously from the reservoir into the source bottle through the filling and venting system,
turnover the assembly thus formed, to once again place the refillable dispenser above the source bottle,
unscrew the refillable dispenser on the threaded neck, and
optionally, screw the dispensing head back onto the threaded neck.

14. : The filling method according to claim 13, wherein the filling and venting system comprises a controllable valve, which is manually actuated by an axial movement along the longitudinal axis between a closed state and an open state, the method comprising an additional step between the steps c—and d—consisting in pulling on the refillable dispenser while holding the source bottle.

15. : The filling method according to claim 13, wherein the filling and venting system comprises a controllable valve, which is manually actuated by an axial movement along the longitudinal axis between a closed state and an open state, the method comprising an additional step between steps c—and d—consisting in rotating the refillable dispenser while holding the source bottle
